(19) United States
(12) Patent Application Publication
(10) Pub. No.: US 2001/0030728 A1
(43) Pub. Date: Oct. 18, 2001

(54) Liquid crystal display and inspection method thereof

(76) Inventors: Shinji Takasugi, Yokohama-shi (JP); Katsuro Hayashi, Fujisawa-shi (JP)

Correspondence Address: IBM CORPORATION, T.J. WATSON RESEARCH CENTER, P.O. BOX 218, YORKTOWN HEIGHTS, NY, 10598, US

(21) Appl. No.: 09/681,418

(22) Filed: Mar. 30, 2001

(30) Foreign Application Priority Data
Mar. 30, 2000 (JP) 2000-92738

(51) Int. Cl. G02F 1/1345

(52) U.S. Cl. 349/149

(57) ABSTRACT

The liquid crystal display includes a connecting terminal, equipped with a light transmitting portion at the picture-frame region, and a conductive portion joined this connecting terminal. The conductive portion provides an electrical connection between two substrates. The picture-frame region is a region outside a display region for displaying an image and makes no contribution to the display of the image. It is preferable that the conductive portion be a transfer and that the connecting terminal be a connecting pad which is a transfer.

### FIELD OF THE INVENTION

The present invention relates to a liquid crystal display and an inspection thereof, and more particularly to a liquid crystal display, which has either the connecting terminal of a conductive portion or a light transmitting portion, and an inspection method thereof.

### BACKGROUND OF THE INVENTION

FIG. 1 illustrates the configuration of a liquid crystal cell in the related art. In the figure, reference numeral 101 denotes a thin-film transistor (TFT) array substrate having a plurality of sub-pixel portions equipped with a TFT. Reference numeral 102 denotes a color filter substrate equipped with a color filter of RGB, reference numeral 103 denotes the edge of a display region, formed from the sub-pixel portions, for actually displaying an image. Reference numeral 104 denotes a picture-frame region that makes no contribution to the display of the image, reference numeral 105 is a polarizer edge, and reference numeral 106 is a color filter substrate edge. Reference numeral 107 denotes an inter-substrate portion that connects the two substrates electrically. Reference numeral 108 a peripheral line that is a conductive line provided in the picture-frame region 104. Reference numeral 110 denotes a liquid crystal filling port, which is enclosed with epoxy resin. Note that a liquid crystal is enclosed between the two substrates. The actual display of an image is performed by inputting an image signal output from a driver ICs (not shown), to the sub-pixel portions and also controlling an electric that is applied across the liquid crystal enclosed between both substrates.

FIG. 2 illustrates the cross section of the picture-frame region 104. In the figure, reference numeral 201 denotes a polarizer for determining the initial polarization direction of transmitted light, reference numeral 202 denotes a light intercepting portion formed from chrome, called a black matrix, reference numeral 203 is a color filter, reference numeral 204 is an indium titan oxide (ITO) electrode, reference numeral 205 is a pixel driver ICs equipped with a TFT, numeral 206 is a liquid crystal, reference numeral 207 is a seal portion for the liquid crystal, reference numeral 208 is a conductive paste called a transfer, reference numeral 209 is a pad as a connecting terminal. The conductive paste 208 and the pad 209 configure the inter-substrate connecting portion. The width of the peripheral portion is approximately 2.2 mm and the inter-substrate distance is approximately 5 μm.

A driver IC (not shown) is connected to the pad 209 through the peripheral line 108 so that a common potential is applied to the ITO common electrode on the filter substrate 102 through the transfer 208. The conductive paste is, for example, silver particles contained in a mixture of ethylene glycol acetate monobutyl ether and benzyl alcohol. At the time of heating after cell fabrication, the organic solvent evaporates, leaving behind only silver particles that have fixed into position.

In the fabrication of the liquid crystal display unit, the mounted position and form of the transfer 208 are inspected after the two substrates have been superposed to fabricate the liquid cell. The reason is that unless the transfer 208 is formed at a predetermined position and in a predetermined form, a contact defect an error in the gap between both substrates will occur. Particularly, if the transfer 208 protrudes outside the pad 209, there is a great possibility that the above-mentioned defect will arise. This inspection is visually performed by the use of an optical microscope.

Shown in FIG. 3 is an inspection mark 301 used in the conventional method of inspecting the transfer 208. In the figure, reference numeral 301 an inspection mark formed from the same material as the light intercepting portion 202, the inspection mark being formed on the opposite surface side of the array substrate of the color filter substrate 102. Reference numeral 302 denotes a color-filter light intercepting layer, and reference numeral 303 denotes a metal pad on array substrate 101.

The inspection mark 301 is a circle with a diameter of about 7500 μm, which equipped with an opening inside. Through this opening, the opposite side of the color filter substrate can be visually viewed. Therefore, through the color filter substrate 102 and this opening, the state of the transfer 208 can be visually inspected.

FIG. 4 shows a sectional view of the conventional inter-substrate connecting portion 107. Reference numeral 401 denotes a gate line layer and reference 402 is a signal line layer. The thickness of each layer is approximately 2000 Å and the diameter of the pad 209 is approximately 750 μm. The gate line layer 401 is composed of a MoW alloy. The signal line layer is composed of a 3-layer metal of Mo—Al—Mo and a insulating layer 403 is composed of SiO₂. The inspection of the transfer 208 is visually performed through the color filter substrate 102.

A conventional method of fabricating the conductive pad 209 will be described with reference to FIGS. 5 through 8. First, the gate line layer 401 is deposited on the array substrate 101, and a column of about 750 μm is formed by a photolithographic process and an etching process (FIG. 5). Subsequently, the SiO₂ insulating film 403 is deposited on the array substrate 101 (FIG. 6), and the SiO₂ insulating film 403 on the gate line layer 401 is removed by the process and the etching process (FIG. 7). Furthermore, the signal line layer 402 deposited on the array substrate 101, and the signal line layer is removed from picture-frame region other than on the gate line layer 401 by the process and the etching process, whereby the pad 209 is formed by the gate line layer 401 and the signal line layer 402. Since the photolithographic process and etching process are well known in the prior art, a description thereof is omitted.

In the conventional inspection method, as described above, the inspection having the same material as the black matrix is provided in the color filter wherein an inspection can be made. However, in recent years, in order to make the display region of a liquid crystal display as large as possible with respect to the display, the picture-frame region width (distance from the image display portion edge to the substrate edge) becomes smaller and the distance between the light intercepting layer and the substrate edge, required for device fabrication, becomes smaller, so that it has become difficult to dispose a position measuring pattern as inspection mark, at the color filter substrate. As a method of eliminating this problem, as disclosed in Published Unexamined Patent Application No. 3-58024, it is considered that an opening is provided in the light intercepting layer on the filter substrate so that the conductive paste can be viewed through the color filter substrate. However, this method is undesirable, because the provision of the opening in the light intercepting layer of the display region allows the entry of light into the display region through this opening and results in light leakage.

The present invention has been made in view of the aforementioned problems found in the prior art. Accordingly, it is an object of the present invention to a liquid crystal display and an inspection method thereof which are capable of inspecting the connected state of a conductive portion effectively. Another object the invention is to provide a liquid crystal display and an inspection method which are capable of inspecting the connected state of a transfer, while the electrical connection between a pad and the transfer. Still another object of the invention is to provide a liquid crystal display which is capable of inspecting the connected state of the conductive portion effectively and being fabricated with A further object of the invention is to provide a liquid crystal display and an inspection method thereof which are capable of inspecting the connected state of a transfer, with the smallest possible number of openings.

### SUMMARY OF INVENTION

The liquid crystal display according to the present invention includes a connecting terminal, equipped with a light transmitting portion at the picture-region, and a conductive portion joined to this connecting terminal. The portion provides an electrical connection between two substrates. The picture-region is a region outside a display region for displaying an image and makes no contribution to the display of the image. It is preferable that the conductive portion be a transfer and that the connecting terminal be a connecting pad which is a transfer.

The connecting terminal is equipped with the light transmitting portion that transmits light, and through this light transmitting portion, the opposite side can visually viewed. It is desirable that the light transmitting portion be configured by a conductive member which transmits light. It is more desirable that the light transmitting portion be formed from the same material as the transparent The material of the transparent electrode may employ indium titan oxide (ITO) or indium zinc oxide (IZO). Also, in the case where a portion of the connecting is formed from material which does not transmit light, it is preferable that the light non-transmitting portion be formed from the wiring material within the sub-pixel portion.

The present invention includes a method of inspecting the above-mentioned liquid crystal display. The method includes the steps of setting the liquid crystal display to be viewed by an optical microscope and visually inspecting the state between the conductive portion and the connecting terminal through the light transmitting portion formed in the connecting terminal. It is preferable that the connecting terminal be a connecting pad formed on the array substrate and that conducting portion be a transfer which connects the array substrate and the opposite substrate electrically. Inspection is visually performed through the array substrate.

Various other objects, features, and attendant advantages of the present invention will become more fully appreciated as the same becomes better understood when considered in conjunction with the accompanying drawings, in which like reference characters designate the same or similar parts throughout the several views.

### BRIEF DESCRIPTION OF DRAWINGS

FIG. 1 is a schematic view showing the configuration of a conventional liquid crystal cell.

FIG. 2 is a sectional view showing the configuration of the conventional picture-frame region.

FIG. 3 is a schematic view showing the configuration of the conventional conductive pad.

FIG. 4 is a sectional view showing the configuration of the conventional substrate connecting portion.

FIGS. 5 to 8 illustrate a conventional method of fabricating a conductive pad.

FIG. 9 is a schematic diagram showing the configuration of a liquid crystal according to an embodiment of the present invention.

FIG. 10 is a sectional view showing the configuration of the inter-substrate connecting portion of the embodiment.

FIG. 11 is a schematic diagram showing the structure of the conductive pad the embodiment.

FIGS. 12 to 16 illustrate a method of fabricating the conductive pad to an embodiment of the present invention.

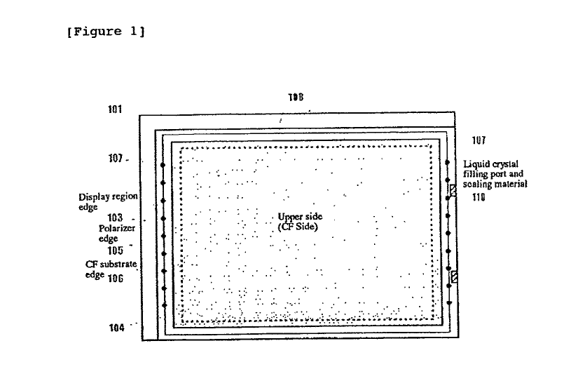

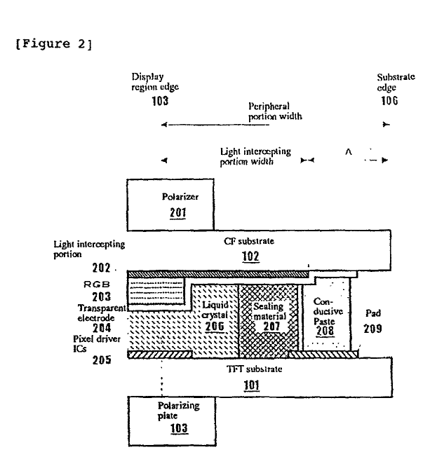

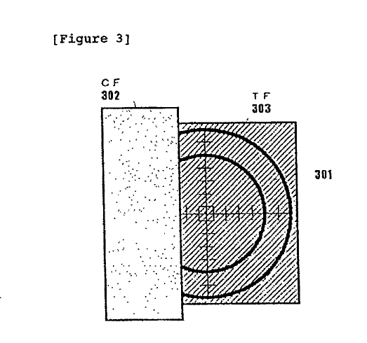

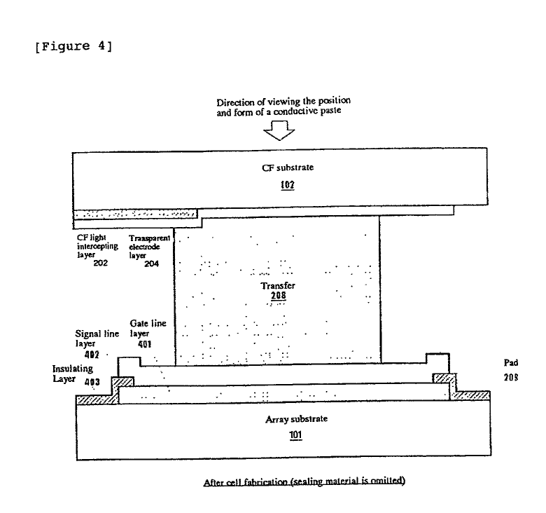

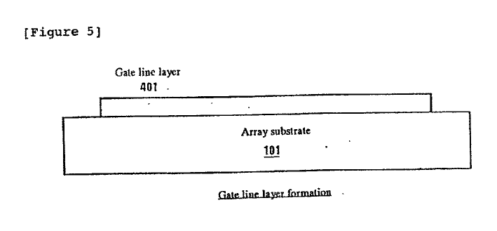

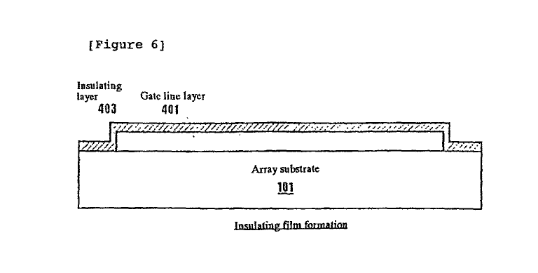

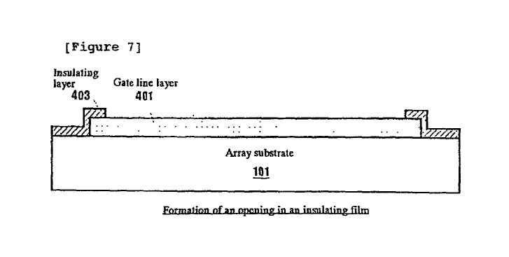

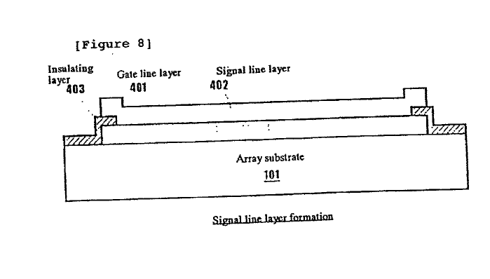

### DETAILED DESCRIPTION

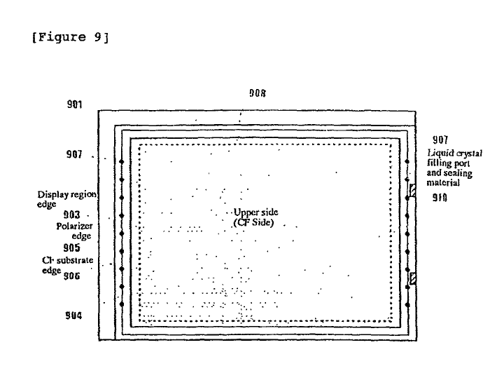

A preferred embodiment of the present invention will be described. In the following description, the same reference numerals denote the same parts as or corresponding parts for avoiding redundancy. FIG. 9 schematically illustrates the configuration of a liquid crystal cell according to a preferred embodiment. In the figure, reference numeral 901 denotes a TFT array substrate having a plurality of sub-pixel portions equipped with a TFT. Reference numeral 902 denotes a color filter substrate equipped with a color filter for RGB, and reference numeral 903 denotes the edge of a display region, formed from the sub-pixel portions, for performing an actual display of an image. Reference numeral 904 denotes a frame region formed outside the display region. The picture-frame region 904 that makes no contribution to the display of the image is formed between the display region edge 903 and the array substrate edge. Note that each sub-pixel portion a TFT and a one-color filter, the 3 sub-pixel portions for R (red), G (green), and B (blue) constituting a single pixel portion.

Reference numeral 905 denotes a polarizer edge, and reference numeral 906 denotes a color filter substrate edge. Reference numeral 907 denotes an inter-substrate connecting portion that connects the two substrates electrically. numeral 908 denotes a peripheral line that is a conducting line provided in the picture-frame region 904. Reference numeral 910 denotes a liquid crystal filling port, which is enclosed with epoxy resin. Note that a liquid crystal is enclosed between the two substrates. The actual display of an image is performed by inputting an image signal output from a driver ICs (not shown), to the sub-pixel portion and also controlling an electric field that is applied across the liquid crystal enclosed between both substrates.

The two substrates are glass substrates and have transparency. Note that it is possible to use resin substrates as the two substrates. The inter-substrate connecting portions 907 are formed on the two opposite sides of the liquid crystal cell, and Ofive connecting portions 907 are formed on each side. This provides a reliably common potential supply to the ITO film, because the ITO film has a relatively high resistance. Driver ICs (not shown) are mounted on the left side and upper side of the picture-frame region 904, respectively. Common potential is applied to the inter-substrate connecting portions 907 through the peripheral line 908 from these ICs and is further sent to the transparent electrode of the color substrate 902.

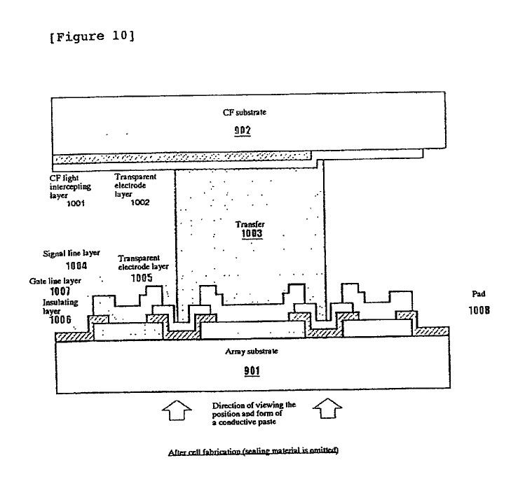

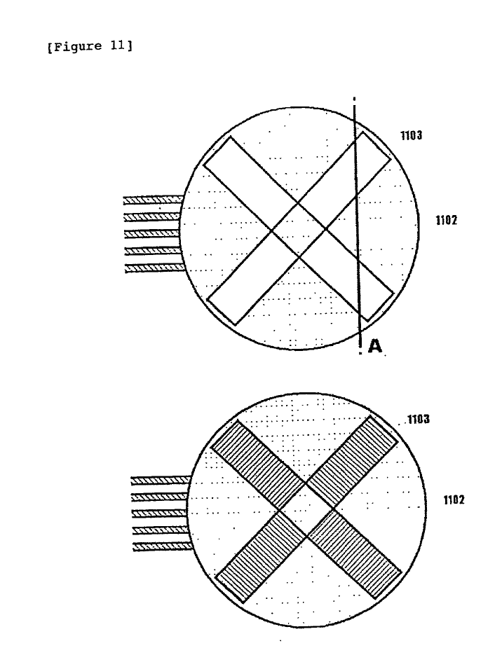

FIG. 10 shows a sectional view, taken along a line A in FIG. 11, of the configuration of the picture-frame region 904. In the figure, reference numeral denotes a light intercepting film that is called a black matrix formed on the color filter substrate 902. The light intercepting film 1001 is formed on the surface of color filter substrate 902 which faces the array substrate 901. The light film 1001 is formed from metal such as chrome, or from resin such as acrylic resin mixed with a black pigment. Reference numeral 1002 denotes an ITO transparent electrode formed on the color filter substrate 902 and reference numeral 1003 a conductive paste (transfer). Reference numeral 1004 denotes a signal line layer, reference numeral 1005 a transparent electrode layer, reference numeral 1006 an insulating layer, and reference numeral 1007 a gate line layer. The thickness of layer is approximately 2000 Å. The signal line layer 1004 is formed at the same time as the signal wiring within the sub-pixel portion (within the display region). signal wiring in the sub-pixel portion is wiring for sending an image signal to the source of the TFT formed on the sub-pixel portion. The transparent electrode layer 1005 is formed at the same time as the transparent electrode that is formed on the sub-pixel portion.

The transparent electrode is an electrode for applying an electric field across liquid crystal. The insulating layer 1006 is formed at the same time as the gate insulating layer within the sub-pixel portion. The gate line layer 1007 is formed at the same time as the gate wiring for the TFT within the sub-pixel portion. The gate wiring is wiring for controlling the gate potential on the TFT. The signal line layer is composed of metal using aluminum (A1). More specifically, the signal line layer has three-layer structure of Mo—Al—Mo. The gate line layer is composed of a Mo alloy such as MoW. The insulating layer is composed of SiO and has light transparency. The transparent electrode layer 1005 is composed of ITO which is the same as the transparent electrode within the sub-pixel portion on the array substrate.

The transfer 1003 is connected to the conductive pad 1008 and to the transparent electrode layer 1002 on the side of the color filter substrate 902. in this embodiment, the transfer 1003 is directly connected to the transparent electrode layer 1002, it is also possible to connect both electrically through conductive material. The conductive pad 1008 is electrically connected to the peripheral line 908 so that it can supply common potential to the transparent electrode layer on the side of the color filter substrate 902 through the transfer 1003. The peripheral line 908 is formed from the same material as the gate line layer and the signal line layer.

The conductive pad 1008 as a connecting terminal is formed by the signal line layer 1004, the transparent electrode layer 1005, the insulating layer 1006, and gate line layer 1007. While a seal portion is actually formed on the side of display region of the conductive pad 1008, it is omitted for explanation. As shown, the intercepting film 902 is superposed on the transfer 1003 and extends up to the central portion of the transfer 1003. Because of this, the connected state of the transfer cannot be inspected from the outside of the color filter substrate 902. The distance between the two substrates is approximately 5 μm. The diameter of the conductive pad 1008 is approximately 750 μm. Note that the form of the pad is not limited to a circular but may be other shapes such as a square, etc.

A method of superposing the two substrates in fabricating the liquid cell will now be described. The conductive paste 1003 is applied to the array substrate 901 having desired sub-pixel portions. Thereafter, the seal portion is formed, and both substrates are superposed while performing alignment. Furthermore, fine (fine adjustment) is performed, and both substrates are heated to about 180° C., while they are being pressurized. In this manner the seal portion and the paste 1003 are hardened. After the liquid cell has been fabricated by such a the connected state of the transfer 1003 is inspected. Note that the conductive portion is called a conductive past from the viewpoint of its material and a transfer from the viewpoint of its function.

FIG. 11 shows the conductive pad 1008 viewed through the TFT array. In the figure, reference numeral 1102 denotes a light transmitting portion in which a transparent electrode, which is a pixel electrode, is formed. Through this light transmitting portion, the connected state of the transfer 1003 connected on the opposite side can be visually confirmed. Reference numeral 1105 denotes wiring connecting the pad and the peripheral line. There are 4 (four) separated light transmitting portions. The light transmitting portions adjacent in the peripheral direction of the pad are disposed at angles of approximately 90 degrees, and the two transmitting portions facing each other in the radial direction are disposed substantially parallel.

If the light transmitting portions are formed and disposed in this manner, the connected state of the transfer can be effectively confirmed with the smallest area. Of course, it is considered that many light transmitting portions are formed to enhance visual field characteristics. The area of the light transmitting portions is determined in consideration of the balance between the visual field characteristics and the transfer-pad conduction. It is preferable that the width in the peripheral direction of the light transmitting portion be as small as possible from the of conduction and made the smallest in the range that the resolution of an optical microscope permits.

Since it will be sufficient if the lower surface edge portion of the transfer can viewed through the light transmitting portions, it is also possible to dispose light transmitting portions, which have a short side in the radial direction, at positions where the edges of the transfer are formed, without making the light transmitting portions long in the radial direction, as in this embodiment. In addition, the conductive material of the light transmitting portion is not limited to ITO but may other materials if they transmit light and are conductive. For example, there are transparent resin, etc., which contain indium zinc oxide (IZO) and metal particles. While, in this embodiment, the light transmitting portion is buried with ITO, as shown in a lower diagram of FIG. 11, an array of openings in the form of a slit, in which small openings are continuously disposed, can also be provided in the signal ling layer and the data line layer so that nothing is buried in the array of openings. Thus, by forming an array of continuous openings, the required conduction can be assured between the pad and the transfer, even if a conductive material is not in the opening. Furthermore, while, in this embodiment, 4 separated openings been formed, 3 separated openings, for example, can also be formed at angles of approximately 120 degrees in the peripheral direction of the pad.

In this embodiment, the inspection of the connected state of the transfer is performed with the liquid cell set to an optical microscope. Through the TFT array, the liquid cell is visually inspected. In the pad 1008, the light transmitting portion 1103 is formed from ITO, and through it, the connected state of the transfer on the opposite side of the pad can be confirmed. Through the array substrate and the transmitting portions of the pad, it is confirmed that the edge portion of the is located at a predetermined position. In this manner the inspection of the connected state of the transfer is performed. Particularly, since there are 4 light transmitting portions, the connected state of the transfer can be confirmed at the position where the transfer edge portion is confirmed through the 4 light transmitting portions, even when the transfer is not circular, such as elliptic, etc., shape.

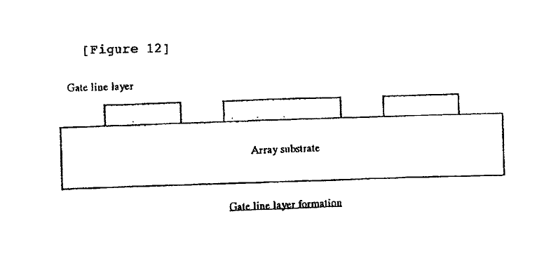

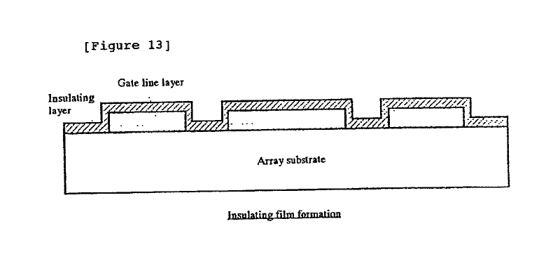

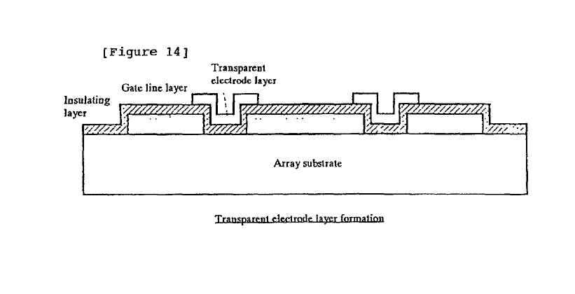

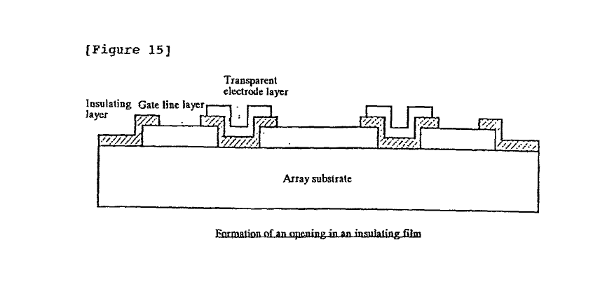

The method of fabricating the pad 1008 will now be described with reference FIGS. 12 through 16. Formation of the pad 1008 is performed at the same time that of the wiring structure within the display region. First, the gate line layer is deposited on the TFT array substrate, and predetermined portions are removed by the photolithographic process and the etching process. Four openings are formed those portions of the gate line layer which correspond to the pad (FIG. 12). Then, an insulating layer is deposited on the array substrate (FIG. 13). Thereafter, a transparent electrode layer is deposited on the array substrate, and predetermined portions are removed by the photolithographic process and the etching process. In the configuration portion of the pad, pattern formation is performed so that the transparent electrode layer is formed on the openings of the data line layer (FIG. 14). Furthermore, the insulating film deposited on the gate line layer is removed by the photolithographic process and the etching process (FIG. 15).

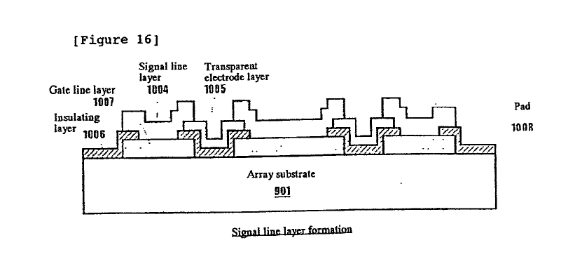

Subsequently, a signal line layer is deposited on the array substrate, and predetermined portions are removed by the photolithographic process and the etching process. In the configuration portion of the pad, the signal line layer deposited on the transparent electrode layer is removed, whereby the light transmitting portions are formed (FIG. 16). The aforementioned process does require an additional step for forming the pad, because it can be formed at the time as the electrodes and wiring within the sub-pixel portions on the array substrate by changing the mask pattern of photoresist. Since the photolithographic process and the etching process are well known in the prior art, a detailed description thereof is omitted. While, in this embodiment, the depositing and removing processes have been performed in the order of gate wiring→insulating layer→transparent electrode layer signal line layer, the order can also be changed according to the wiring structure within the display region. In the case where the order is changed, the order of the deposited layers is also changed correspondingly.

The connecting terminal preferably has a plurality of light transmitting portions separated, and the light transmitting portions are disposed at angles of approximately 90 degrees in the peripheral direction of the pad. This light transmitting portion is disposed at a normal position where the edge of the is superposed. The light transmitting portion can also be formed by disposing of a plurality of separated light transmitting portions. With such disposition, one array of light transmitting portions is formed in the form of a slit. In this case, the light transmitting portion can also be left open without being buried with a conductive member.

It is preferable that the light transmitting portion have four transmitting portions, which are configured by the same material as the transparent electrode and disposed at angles of approximately 90 degrees in the peripheral direction of the pad. Inspection is performed by confirming the position of the edge of the transfer through the light transmitting portions. Note that the above-mentioned liquid crystal display is the concept of including liquid crystal cells, liquid crystal modules, and liquid crystal displays.

As described above, in this embodiment, it becomes possible to confirm the connected state of the transfer through the TFT array substrate and the light transmitting portions, because the light transmitting portions are provided in the conductive pad to which the transfer is connected. With this arrangement, it becomes possible to perform inspection in liquid crystal displays, where edge-narrowing is being performed, without degrading device characteristics, even when the light intercepting layer on the color filter side is superposed on the transfer.

The material of the transparent electrode may employ indium titan oxide (ITO) indium zinc oxide (IZO). Also, in the case where a portion of the connecting is formed from material which does not transmit light, it is preferable that the light non-transmitting portion be formed from the wiring material within the sub-pixel portion.

It is preferable that the connecting terminal be a connecting pad formed on the array substrate and that the conducting portion be a transfer which connects the array substrate and the opposite substrate electrically. Inspection is visually performed through the array substrate.

It is to be understood that the provided illustrative examples are by no means exhaustive of the many possible uses for my invention.

From the foregoing description, one skilled in the art can easily ascertain the essential characteristics of this invention and, without departing from the spirit scope thereof, can make various changes and modifications of the invention to adapt it to various uses and conditions.

It is to be understood that the present invention is not limited to the sole embodiment described above, but encompasses any and all embodiments within scope of the following claims.

1. A liquid crystal display, comprising:
a first substrate;
a second substrate facing said first substrate; and
a liquid crystal enclosed between said first and second substrates; wherein
said first substrate has:
a display region, configured by a plurality of sub-pixel portions, for
an image;
a peripheral portion formed outside said display region;
a connecting terminal, formed in said picture-frame region, which has a light
transmitting portion; and
a conductive portion jointed to said connecting terminal; and
said second substrate has a conductive layer, and
said conductive portion is electrically connected to said conductive layer.

2. The liquid crystal display as set forth in claim 1, wherein said light transmitting portion is configured by a conductive member that transmits light.

3. The liquid crystal display as set forth in claim 2, wherein said conductive member is composed of indium titan oxide (ITO).

4. The liquid crystal display as set forth in claim 2, wherein said connecting terminal is configured by a light non-transmitting portion, formed from a wiring material within said second pixel portion, and a light transmitting portion, formed from a transparent electrode material within said sub-pixel portion.

5. The liquid crystal display as set forth in claim 1, wherein said connecting terminal has a plurality of light transmitting portions separated from one another, each of said light transmitting portions being superposed on an portion of said conductive portion.

6. The liquid crystal display as set forth in claim 1, wherein said connecting terminal has 4 light transmitting portions separated from one another, said 4 light transmitting portions being disposed at angles of approximately 90 degrees in a peripheral direction of said connecting terminal.

7. The liquid crystal display as set forth in claim 1, wherein said light transmitting portion is configured by arrays of a plurality of light portions separated from one another.

8. The liquid crystal display as set forth in claim 1, wherein said first is a substrate with an array of a plurality of thin-film transistors disposed in array;
said second substrate is a substrate with a color filter;
said conductive layer is a transparent electrode for applying an electric field
said liquid crystal;
said connecting terminal is configured by the wiring material and transparent
electrode material within said sub-pixel portion;
said conductive member is a transfer composed of a thermosetting paste; and
said transfer is electrically connected to the transparent electrode on said color filter substrate.

9. A method of inspecting a liquid crystal display, said liquid crystal display, comprising:
an array substrate with switching elements disposed in the form of a matrix;
an opposite substrate facing said array substrate;
a connecting terminal with a light transmitting portion formed on said array substrate; and
a transfer, joined to said connecting terminal, and electrically connected to electrode on said opposite substrate,
said method, comprising the steps of:
setting said liquid crystal display to an optical microscope;
visually confirming said liquid crystal display set to said optical microscope; and
visually confirming an connected state of said transfer through said array substrate and the light transmitting portion of said connecting terminal.

10. A liquid crystal display comprises:
a connecting terminal; and
a conductive portion joined to said connecting terminal; wherein said conduction portion provides an electrical connection between two substrates and is transmissive, and that the connecting terminal, being a conductive is also light transmissive.

11. A connecting terminal, comprising:
a light transmitting portion that transmits light, and through this light transmitting portion, the opposite side of the light transmitting portion can visually viewed, said light transmitting portion is configured by an electrical conductive member which transmits light; and
a transparent electrode;
wherein said light transmitting portion is formed from the same material as the transparent electrode.

12. A method of setting a liquid crystal display to be viewed by an optical microscope and visually inspecting a connected state between a conductive portion and a connecting terminal through a light transmitting portion in the connecting terminal, comprising the steps of:
providing an array substrate;
providing an opposite substrate facing said array substrate;
providing a connecting terminal on said array substrate, said connecting terminal includes light transmitting properties; and
joining said array substrate and said opposite substrate by using an optical electrical transfer.
